(19) United States
(12) Patent Application Publication
(10) Pub. No.: US 2004/0055398 A1
(43) Pub. Date: Mar. 25, 2004

(54) Method and device for monitoring the pivot bearings, particularly the rolling bearings, of continuous casting supporting rollers mounted in a supporting roller stand of metal, especially steel, continuous casting devices

(76) Inventors: Axel Weyer, Wuppertal (DE); Horst Von Wyl, Duisburg (DE); Gerhard Grelewitz, Rheinberg (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/344,167

(22) PCT Filed: Jul. 25, 2001
(86) PCT No.: PCT/EP01/08584

(30) Foreign Application Priority Data
Aug. 10, 2000 (DE) 100 39 015.3

(51) Int. Cl. G01L 5/12

(52) U.S. Cl. 73/862.49

(57) ABSTRACT

The invention relates to a method and device for particularly the rolling bearing (3a), if continuous casting supporting rollers (2), which are mounted on both sides and/or centrally in a supporting roller stand (1) of metal, especially steel, continuous casting devices, by using sensors arranged in the proximity. The invention does not make the exchange of the pivot bearings (3) dependent on the occurrence of damages but targets it at the cost-effectiveness and the most-measurement and storage of the mechanical and/or thermal stresses (load collective) on at least one or more pivot bearings (3) or on selected groups of pivot bearing (3) or on a part 1a) that influences that pivot bearing 3) are effected for determining the remaining serviceable life of the rolling bearings and/or slide bearings (3a). In addition, the digital mearsurement results are processed in an evaluation and storage unit (5; 6), and a ratio consisting of the load collective and of the limiting load capacity or the respective pivot bearing (3; 3a) is calculated from the total number of all stresses.

The invention relates to a method of and a device for monitoring the rotary bearings, especially the roller bearings of continuous casting support rollers journaled at both ends and/or centrally in a support roller frame of a metal, especially a steel, continuous casting apparatus by sensors arranged in the proximity thereof.

In continuous casting apparatuses for slab cross sections, thin strands, billets and/or beam blanks, the strand from the continuous casting mold through at least the region in which it is fully solidified is supported in a roller corset and is fed and during the advancing solidification is also bent, the forces which arise are taken up by the continuous casting support rollers and their rollers or slide bearings and transmitted to the roller support frame. During the operation, which can continue generally for many days or weeks without interruption, stresses of different types and magnitudes arise. An evaluation of these stresses at the time of construction of the apparatus can be only approximate and with coarse simplifications, approach the conditions arising in later actual casting operations. Such rotary bearings can therefore fail as a consequence of the detrimental effect of continuous, slight or individual high stresses or from a combination of these loads. The damage can also arise when each individual stressing situation by itself would not give rise to any damage. Fro the case in which there is such a failure during casting operation, the operation must be interrupted and the result, including possibly required repairs can be increased output failure and cost. The operators of these continuous casting apparatuses deal with this possibility mainly by a regular and preventative replacement of the rotary bearings it is unavoidable in such cases, although uneconomical, that the useful life of many rotary bearings will not be fully utilized so that certain bearings can be reliably prevented from breakage.

It is known (from FEATURE, in the article “Measurements and Calculations of the Temperature and Load of the Bearings in a Continuous Casting Machine at BOS No. 2 in Ijimuiden”, December 1999, Pages 25-29), to monitor bearings for various features and to delay a replacement until an effective damage is directly at hand. Thus it is known to recover by means of acceleration sensors or body-sound sensors a signal which, by appropriate evaluation, for example of the frequency bands, provides an indication of the actual state of the bearings. This method depends, however, like also the other methods on the analyses of the change in significant characteristics of the bearings and can thus first respond when a change has already occurred. There is a danger that a first indication may be too late under some conditions and the damage will nevertheless occur.

The presently mentioned method allows an evaluation of the useful life of machine components. This method is based upon the fact that each individual stress on a component contributes a certain amount of its overall deterioration substantially up to a first detectable flaw. All of the stresses acting on a component can be assembled into a so-called load collective during a particular observation period. Thus, for example, it is possible to calculate after what time and under what course of stresses and as to what probability of failure of the observed component can be expected. Such evaluations can be the more precise as to effects of the stresses-depending upon type, direction, magnitude and frequency—are included in the calculation. The failure rates which must be presumed based upon the material properties are today so small that they as a rule only influence to a negligible extent the overall hit rate of such estimations.

It is also known (“Leitfaden für eine Betriebsfestigkeitberechnung”—VDEhVerlag Stahl-Eisen, Düsseldorf 1985, 2nd Edition) to use a method and device for measuring bearing stresses, for example, force-measuring boxes, special measurement bearings or the application of bearing or bearing usings with corresponding sensors. In addition, the continuous casting apparatus is subjected to detrimental environmental conditions including high temperatures, steam with chemically aggressive components, dirt and mechanical stresses which can nowadays be the subject of measurement technology.

Through the use of corresponding measurement techniques (force-measuring boxes, special measurement bearings, rotary bearings with sensors), the undesirable environmental conditions which may prevail in the continuous casting apparatus, like for example high temperatures, steam with chemically aggressive components, dirt and mechanical stresses can be considered.

It is the object of the invention to avoid the replacement of rotary bearings not based upon the occurrence of damage but rather to make the replacement more economical for the continuous casting operation and enable a significantly better utilization of a rotary bearing and at a more economically favorable repair point in time.

The specified object is based upon the detection not of a change in the rotary bearings but the prediction of change by the detection of external influences on the rotary bearing and the evaluation of a possible breakdown based thereon.

The specified object is achieved, in accordance with the invention by a determination of the residual life a roller and/or slide bearing by a continuous measurement and storage and the mechanical and/or thermal stresses (load collective) on at least one or on a plurality of rotary bearings or on a selective group of rotary bearings or on a component which is influenced by the rotary bearing, the digital measuring results being processed in an evaluation and storage unit and, from the totality of all of the loads, a ratio is calculated from the load collective and the limiting load capacity of the respective rotary bearings. In this manner it is possible to reduce or completely avoid unpredictable operational failures as a consequence of defects in the rotary bearings. Furthermore, it is advantageous that a prophylactic replacement of the rotary bearings can be completely eliminated and maintenance of them only undertaken when they physically provide a warning of the need for that maintenance. The rotary bearings can thus be utilized always up to their calculated limiting life. In accordance with the invention, long-term experiences as to the wear history of the continuous casting machine can be collected and thus can be used on the one hand to optimize the manner of operating the casting apparatus and on the other hand to optimize its dimensioning and configuration. In addition, overload cases can be used to assist in possible failure tests in analyzing them on a time or process dependent basis. Advantageously changes can be determined by reproducible paradigms (load samples) and can support or enable diagnosis by comparison with a previously-determined original state to contribute to changes in the machine construction. Simultaneously, fabrication, mounting and adjustment defects can be identified. All of the advantages depend upon the accumulation of the total stress from a multiplicity of small stresses as well as a reduced number of high stresses over different time periods, of continuous static or quasistatic loads (for example from the intrinsic weight of the support structure) via increasing or alternating loads, for example from fluctuating operating stresses) up to highly dynamic shock-like stresses.

In view of the multisided data acquisition, it is advantageous in accordance with a refinement of the invention that the acquisition of the measurement data is carried out at a fixed scanning rate. One therefore strives to effect the data acquisition on the one hand at a relatively high frequency, for example with a 50 Hz scanning rate. On the other hand however, this data should be acquired also over very long time periods, for example, several years.

A further step resides in that the acquired measurement data is processed in accordance with a statistical process. As a result the cost of the apparatus for storage and evaluation can be held within reasonable limits. It is not however required to directly store raw data.

According to another step it is advantageous to sort and store the acquired measurement data in accordance with the type, direction, magnitude and duration of the load.

In accordance with further features, it is proposed to detect from the measurement data the tolerable summed total loading of the individual roller bearing and to compress it to a key value [coefficient] which represents the accumulated total stress up to the actual measurement point in time of the roller bearing. This total loading is compared with the limiting load. The comparison yields information as to the residual life to be expected. This method also simplifies the continuous act of keeping the expected residual life current because through the individual class sizes, a weighing of an individual measurement result in proportion to the previously already evaluated results is possible. Aside from the described statistical evaluation over long time periods, it is advantageous to use the current stress measurement for a direct evaluation. A rapid evaluation is especially useful in operating situations in which detrimental loads may be applied to the rotary bearing which reaches statistically tolerable load limits or tend to exceed it, for example, by restart after a casting interruption or by the withdrawal of an already cooled strand.

Along the lines of the basic concept, it is then further advantageous that the load collective of the bearing to be evaluated is not drawn from individual single measurements but that the bearings from which identical stresses can be detected are assembled into groups and for each a representative measurement is used for evaluation of the actual stress for the entire group.

It is further advantageous that the groups and/or a differentiation of the stress distribution within the group is formed based upon numerical modeling of these groups. For the numerical modeling, the method of finite elements can be used.

According to further features, the measurements can be effected also externally of the rotary bearings. For this purpose it is provided that the bearing loads which apply to a rotary bearing are determinable from a measured value at a component and from that the load distribution is calculated by a mathematical model.

According to a further feature, it is provided that the actual accumulated stress coefficient be compared with a previously determined tolerable stress coefficient and the residual life determined therefrom. In that case, the further stresses to be expected in the future are evaluated by statistical means from the stresses which have resulted from the previous operation in the form of a current expected residual life.

A device for monitoring the rotary bearing, especially the roller bearings of continuous casting support rollers which are journaled at both ends and/or centrally in a support roller frame of a model continuous casting apparatus, especially a steel continuous casting apparatus, by sensors arranged in proximity of the rollers, achieves the objects of the invention which have been set forth in that at one or more selected rotary bearings of a continuous casting support roller journaled by means of roller and/or slide bearings, a respective measurement element is disposed for a mechanical and/or for a thermal stress, and in that the measurement element is connected with an evaluation and/or storage unit. Thus the measurement element can be comprised of strain gauge and temperature measurement strips.

To obtain a protected arrangement and one which is protected from heat and moisture, it is provided that the measurement element be arranged respectively on a component of the roller support frame receiving or supporting a roller or slide bearing. In this manner the measurement element can be located at a place on the roller support frame further from the rotary bearing to be evaluated, for example, on the transverse traverse supporting the rotary bearing on its back side of the roller segment or the roller segment frame.

According to a further feature the measurement can be effected also externally of the rotary bearing. For this purpose it is provided that the bearing load which is applied to the rotary bearing be determined from a measured value on a component and the load distribution calculated from a mathematical model.

The storage of the information can, to avoid alteration, be effected with a medium which is disposed on the roller receiving support frame. An advantageous arrangement is provided wherein the measurement element is connected on the electronic storage medium located proximally to the continuous casting support roller. Such storage medium can be, for example, memory chips which are received in corresponding protective housings.

In the drawing the measurement process is illustrated and is described in greater detail below.

The drawing shows:

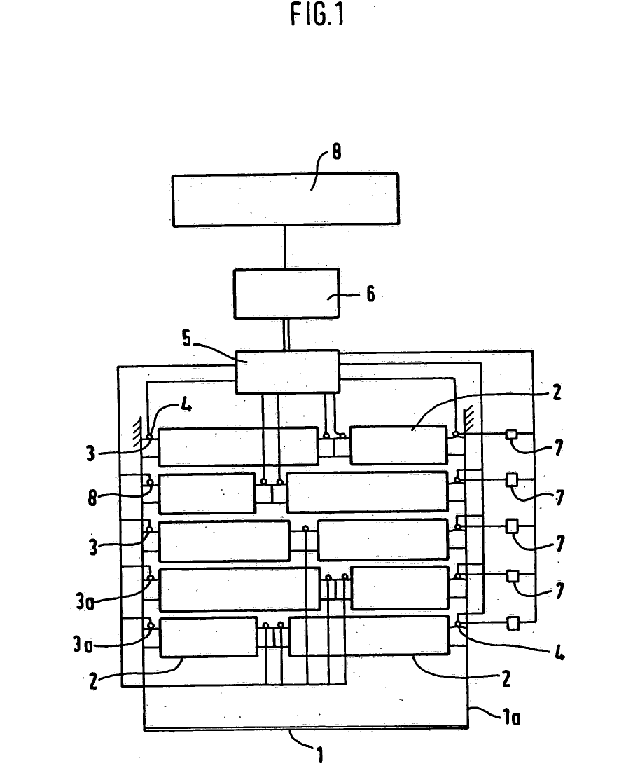

FIG. 1 a block circuit diagram with the arrangement and connection of the measurement elements and the evaluating and storage unit,

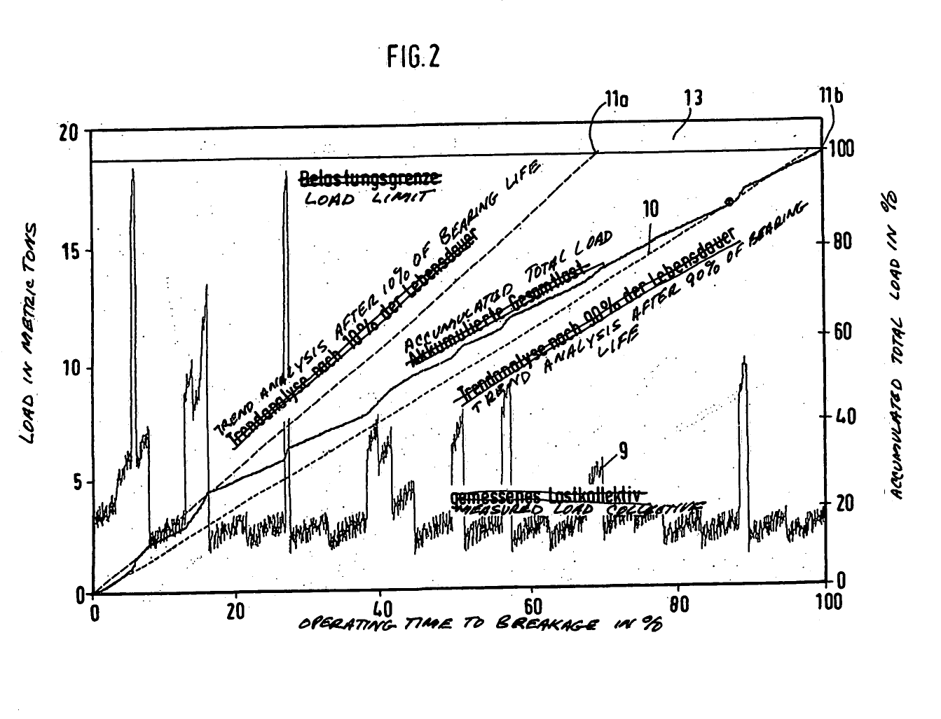

FIG. 2 a load-time diagram and

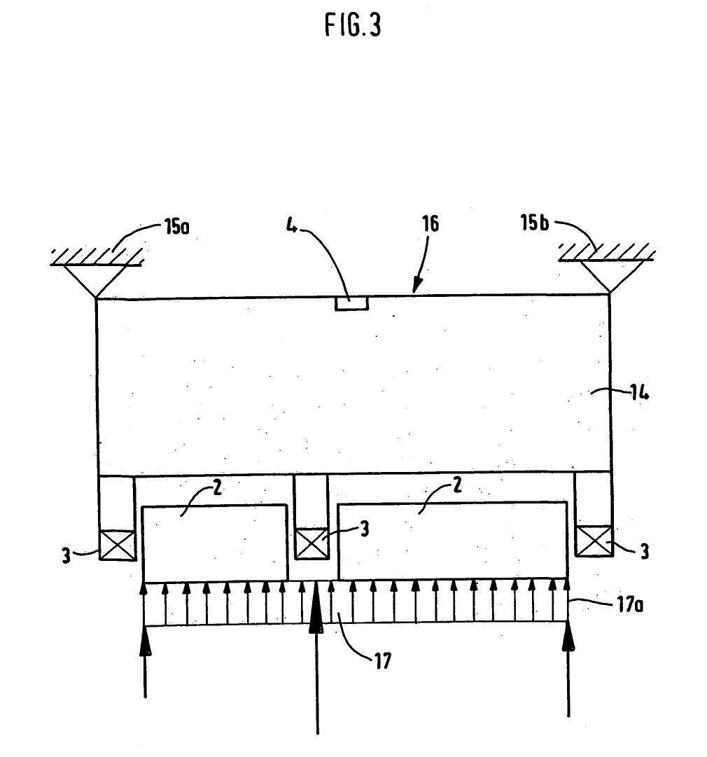

FIG. 3 the arrangement of the sensors on a component located externally of the rotary bearing in an elevational view upon a support roller segment.

In a support roll frame 1 (FIG. 1), respective bearing components 1a of a continuous casting support roller 2 are rotatably mounted and are either roller bearings 3a or plain bearings 3a [slide bearings 3a], whereby for this case mainly roller bearings 3a in the form of pin bearings are used. The continuous casting support rollers 2 can be journaled at both ends with such roller bearings 3a or segmentwise between two continuous casting support rollers 2 with roller bearings 3a. In the region of each rotary bearing 3, measurement elements 4 are arranged in the form of sensors or strain gauge measurement strips. The method of monitoring the rotary bearings 3 is such that, for determining the residual life of the roller and/or slide bearings 3a, a continuous measurement and storage of the mechanical land/or thermal stresses are carried out on at least one or on a plurality of rotary bearings 3 and the digital measurement results, further, are processed in an evaluation unit 5 and a storage unit 6 and from the number of high, threshold or shock-like loads, a limiting life of the respective rotary bearing is calculated. Thereafter, the point in time can be determined at which one or more rotary bearings must be replaced. The acquisition of the measured data at the rotary bearings 3 is carried out at a fixed scanning rate. So that not all of the measurement data must be stored, the acquired measurement data is processed in accordance with a statistical process. Apart from this, the acquired measurement data is sorted in accordance with type, direction, magnitude and duration of the load and then first stored.

Based upon the measured data acquisition from the measured data in the evaluation unit 5, the tolerable summed total loading of the individual roller bearing 3a is determined and compressed to a coefficient which represents the accumulated total stress up to failure of the roller bearing 3a involved. The stress distribution in a support roller frame 3 by group and/or by a differentiation within the group based upon numerical modeling of these groups has been shown. The actual accumulated stress coefficient is compared with a previously determined tolerable stress coefficient and from that the residual life is determined.

The measurement elements 4 can also be respectively arranged on a component receiving the roller or slide bearing 3a or a supporting component 1a of the support roller frame 1. Apart from this, it is provided that the measurement elements 4 be connected to electronic storage media 7, like memory chips, arranged in the vicinity of the continuous casting support rollers 2 and provide that the latter store the measurement data which can be called up by the continuous casting controller 8.

In FIG. 2 in the load-time diagram, a measured load collective is shown as the measurement curve 9. From individual points obtained at short time intervals, it is possible to determine the accumulated total load after a brief period by applying a tangent, in the form of a linear course 10 of the accumulated total load. The respective intersection points 11a and 11b with a load limit as the lower limit of a load limit strip 13 provides an indication of attainment of the acceptable residual life of the rotary bearing 3 involved.

The measurement elements 4 need not, as shown in FIG. 1, be directly arranged on the respective rotary bearing 3 which would make such so-called measurement bearings relatively expensive, but can also be arranged on other parts, for example in a protected location. Such an arrangement is shown in FIG. 3. According to FIG. 3, the measurement element 4 is arranged on the underside 16 of a roller segment frame 14 of a support roller structure 1 of the steel continuous casting plant which is held in foundation supports 15a and 15b and thus measures the bending of the roller segment frame 14. The bending can be measured for example by means of strain gauge strips. The bending results from the weight and pressing force in the cast strand 17 and is illustrated as a statistically determined stretching load 17a. The stretching load 17a is applied via the continuous casting support rollers 2 to the rotary bearings 3. In this manner, for example, from the strain on the measurement element 4, the load distribution can be determined from mathematical modeling and from that and the known operating situation, as the load in an individual rotary bearing.

### Reference Character List

1 Support roller frame

1a Component

2 Continuous casting support roller

3 Rotary bearing

3a Roller bearing, plain bearing

4 Measurement element

5 Evaluation unit

6 Storage unit

7 Electronic storage [memory]

8 Continuous casting plant control

9 Measurement curve (load collective)

10 Linear course

11a Intersection point

11b Intersection point

12 Load limit

13 Load limiting strip

14 Roller segment frame

15a Foundation mount

15b Foundation mount

16 Underside

17 Cast strand

17a Stretch load

1. A method of monitoring the rotary bearings, especially the roller bearings, of continuous casting support rollers which are journaled at both ends and/or centrally in a roller support frame of a metal and especially steel continuous casting apparatus, by means of sensors arranged in their proximity,
characterized in that,
for the determining the residual life of roller and/or plane bearings a continuous measurement and storage of the mechanical and/or thermal stresses (load collective) is carried out on at least one or on a plurality of rotary bearings or on selected groups of rotary bearings or on a component influenced by the roller bearings, the digital measurement results are processed in an evaluation and storage unit, and, from the totality of all loads a ratio is calculated from the load collective and the limiting load capacity of the respective rotary bearing.

2. The method according to claim 1,
characterized in that,
the collection of the measured data is carried out at a fixed scanning rate.

3. The method according to claim 1,
characterized in that,
the collection measured data is processed in accordance with a statistical process.

4. The method according to claim 1,
characterized in that,
the collection measured data is sorted in accordance with type, direction magnitude and duration of the load and stored.

5. The method according to claim 1,
characterized in that,
from the measured data, the tolerable, summed, total loading of the individual roller bearing is determined and compressed to a coefficient which represents the accumulated total stress up to the current measurement time point of the roller bearing.

6. The method according to claim 1,
characterized in that,
the load collective of the examined bearing is not determined from individual single measurements but rather that the bearings which are subject to the same stresses are collected into groups and respectively a representative measurement is used for estimating the actual stress of the entire group.

7. The device according to claim 1,
characterized in that,
the groups and/or a differentiation of the stress distribution within the groups are formed based upon numeric modeling of these groups.

8. The device according to claim 1,
characterized in that,
the bearing load falling upon a rotary bearing is determinable from a measured value at a component and is calculated as the load distribution from a mathematical model.

9. The method according to claim 1,
characterized in that,
the actual accumulated stress coefficient is compared with a previously determined tolerable stress coefficient and from that the residual life is determined.

10. A device for mounting the rotary bearings, especially the roller bearings of continuous casting support rollers which are journaled at both ends or centrally of a support roller frame of a metal, especially a steel, continuous casting apparatus by sensors arranged in the proximity thereof,
characterized in that,
at one or more selected rotary bearings (3) of a continuous casting support roller (2) journaled by means of rollers and/or plain bearings (3a) or on a component (1a) influenced by the rotary bearing (3) respectively, a measurement element (4) is arranged for a mechanical and/or for a thermal stress and that the measurement element (4) is connected with an evaluating unit (5) and/or a storage unit (6).

11. The device according to claim 10,
characterized in that,
the measurement element (4) is respectively arranged on a component (1a) of the support roller frame (1) receiving or supporting one of the roller or slide bearings (3a).

12. The device according to claim 10,
characterized in that,
the bearing loads applied to a rotary bearing (3) are determinable from a measured value at the component (1a) and from a load distribution calculated from a mathematical model.

13. The device according to claim 10,
characterized in that,
the measurement elements are connected with electronic memory (7) arranged in proximity to the continuous casting support roller (2).
